(19) United States
(12) Patent Application Publication
(10) Pub. No.: US 2024/0394667 A1
(43) Pub. Date: Nov. 28, 2024

(54) INFORMATION PROCESSING DEVICE

(71) Applicant: TOYOTA JIDOSHA KABUSHIKI KAISHA, Toyota-shi (JP)

(72) Inventors: Yu Hamada, Nagoya-shi (JP); Kenta Kawashima, Nagoya-shi (JP); Yuichi Mukasa, Kawaguchi-shi (JP); Keisuke Kondo, Nagoya-shi (JP); Yohei Nakanishi, Nagoya-shi (JP)

(73) Assignee: TOYOTA JIDOSHA KABUSHIKI KAISHA, Toyota-shi (JP)

(21) Appl. No.: 18/588,203

(22) Filed: Feb. 27, 2024

(30) Foreign Application Priority Data
May 26, 2023 (JP) 2023-087099

(51) Int. Cl. G06Q 10/20

(52) U.S. Cl. CPC G06Q 10/20

(57) ABSTRACT

The information processing device acquires a recommended period for recommending maintenance of the vehicle for each of the plurality of maintenance items. For a plurality of maintenance items, the information processing device determines the earliest recommended period among the acquired recommended periods as a reference period, and identifies the maintenance item of the earliest recommended period as a reference maintenance item. The information processing device identifies, among the plurality of maintenance items, another maintenance item different from the identified reference maintenance item, the other maintenance item for which the recommended period arrives in a predetermined period including the identified reference period. Then, the information processing device decides to maintain the identified other maintenance items together with the reference maintenance items.

### CROSS-REFERENCE TO RELATED APPLICATION

This application claims priority to Japanese Patent Application No. 2023-087099 filed on May 26, 2023, incorporated herein by reference in its entirety.

### BACKGROUND

### 1. Technical Field

The present disclosure relates to an information processing device.

### 2. Description of Related Art

Japanese Unexamined Patent Application Publication No. 2021-157455 (JP 2021-157455 A) discloses a vehicle management system. The vehicle management system disclosed in JP 2021-157455 A calculates damage of a parts of the vehicle, based on a measurement values by sensors provided in the vehicle, and stores history of the damage. Based on traveling distance of the vehicle, and the history of the damage, a traveling distance at which damage in the future will be no smaller than a predetermined threshold value is predicted.

### SUMMARY

An object of the present disclosure is to improve convenience for a user to perform maintenance of a vehicle.

An information processing device according to the present disclosure includes a control unit configured to execute acquisition of a recommended period for recommendation to perform maintenance of a vehicle for each of a plurality of maintenance items, identification of, with an earliest recommended period of the recommended period that is acquired as a reference period, a maintenance item of the earliest recommended period out of the maintenance items, as a reference maintenance item, identification of another maintenance item out of the maintenance items that is different from the reference maintenance item that is identified, and of which the recommended period will arrive in a predetermined period that includes the reference period that is identified, and decision to perform maintenance of the other maintenance item that is identified, along with the reference maintenance item.

According to the present disclosure, convenience can be improved for a user to perform maintenance of a vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a schematic configuration of a notification system;

FIG. 2 is a diagram illustrating an example of a time series for a plurality of recommended periods;

FIG. 3 is a block diagram schematically illustrating an example of a functional configuration of a management server;

FIG. 4 is a diagram illustrating an example of a table configuration of vehicle information held in a vehicle information database;

FIG. 5 is a diagram illustrating an example of a table configuration of item information held in an item information database;

FIG. 6 is a diagram illustrating an example of a table configuration of user information held in a user information database;

FIG. 7 is a flow chart of a first process executed by the control unit; and

FIG. 8 is a flowchart of a second process executed by the control unit.

### DETAILED DESCRIPTION OF EMBODIMENTS

It is assumed that a user is recommended to perform maintenance of a plurality of maintenance items on a vehicle. At this time, a recommended period for recommending maintenance may be determined for each of the plurality of maintenance items. In addition, the recommended periods for each of the plurality of maintenance items may not overlap. In this case, if the user is proposed to perform the maintenance of the vehicle in each recommended period, the user performs the maintenance of the vehicle in a plurality of recommended periods that do not overlap with each other. As a result, the user may feel inconvenient with respect to maintenance of the vehicle. An information processing device according to the present disclosure solves such a problem.

The control unit of the information processing device according to the present disclosure acquires a recommended period for recommending maintenance of the vehicle for each of the plurality of maintenance items. The control unit of the information processing device identifies, as a reference period, the earliest recommended period among the acquired recommended periods for a plurality of maintenance items. Further, the control unit identifies the maintenance item of the earliest recommended period as the reference maintenance item.

The control unit identifies, among the plurality of maintenance items, another maintenance item different from the identified reference maintenance item, in which the recommended period arrives in a predetermined period including the identified reference period. Then, the control unit decides to maintain the identified other maintenance items together with the reference maintenance items.

As described above, the information processing device decides to maintain other maintenance items together with the reference maintenance items. This prevents the user from performing maintenance of the vehicle in a plurality of recommended periods. As a result, it is possible to improve convenience when the user performs maintenance of the vehicle.

Hereinafter, embodiments of the present disclosure will be described with reference to the drawings. A hardware configuration, a module configuration, a functional configuration, etc., described in each embodiment are not intended to limit the technical scope of the disclosure to them only unless otherwise stated.

### Embodiment

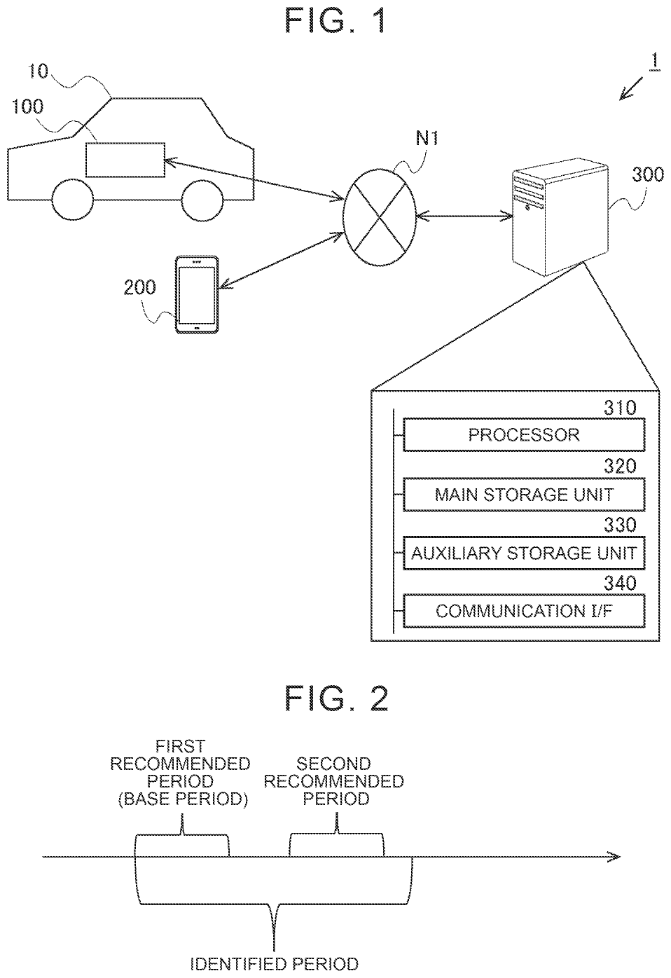

The notification system 1 according to the present embodiment will be described with reference to FIGS. 1 to 2. FIG. 1 is a diagram illustrating a schematic configuration of a notification system 1. In the notification system 1, the in-vehicle device 100, the user terminal 200, and the management server 300 are connected to each other via a network N1. The network N1 may be, for example, a worldwide public communication network such as Internet or the like, and a WAN (Wide Area Network) or a telecommunications network such as a cellular network.

### In-Vehicle Device

The in-vehicle device 100 is an in-vehicle device mounted on the vehicle 10. The in-vehicle device 100 acquires information on the traveling state of the vehicle 10 (hereinafter, sometimes referred to as “vehicle information”) from an electronic control unit that controls the traveling of the vehicle 10. The vehicle information includes, for example, information indicating the travel distance of the vehicle 10. The in-vehicle device 100 transmits the vehicle information to the management server 300 via the network N1.

### Management Server

The management server 300 is a server device that manages the maintenance timing of the vehicle 10. The management server 300 refers to information indicating the travel distance of the vehicle 10 included in the vehicle information received from the vehicle 10, and decides a maintenance item for the vehicle 10. Further, the in-vehicle device 100 refers to information indicating the travel distance of the vehicle 10 and sets a recommended period for recommending maintenance of the vehicle 10.

At this time, the user may perform maintenance of a plurality of maintenance items on the vehicle 10. At this time, a recommended period may be determined for the maintenance of a plurality of maintenance items. In addition, the recommended periods for each of the plurality of maintenance items may not overlap. In this case, if the user is proposed to perform the maintenance of the vehicle 10 in each recommended period, the user performs the maintenance of the vehicle 10 in a plurality of recommended periods that do not overlap with each other. As a result, the user may feel inconvenience in maintenance of the vehicle 10. It should be noted that the user is not necessarily required to perform the maintenance of the vehicle 10 during the recommended period.

FIG. 2 is a diagram illustrating an example of time series for a plurality of recommended periods. In the example illustrated in FIG. 2, two recommended periods of the first recommended period and the second recommended period are set. In the example shown in FIG. 2, the two recommended periods are periods that do not overlap each other. In this case, if the user is proposed to perform the maintenance of the vehicle 10 in each recommended period, the user performs the maintenance of the vehicle 10 in the first recommended period and the second recommended period. As a result, the user performs maintenance twice in total, which may cause inconvenience.

Therefore, the management server 300 decides the earliest recommended period among the plurality of recommended periods as the reference period. In addition, the management server 300 identifies the maintenance item of the earliest recommended period as the reference maintenance item. In addition, the management server 300 identifies another maintenance item different from the reference maintenance item among the plurality of maintenance items, the other maintenance item for which the recommended period arrives in a predetermined period including the reference period. Then, the management server 300 decides to maintain the identified other maintenance items (hereinafter, sometimes referred to as “identified items”) together with the reference maintenance items.

In the example shown in FIG. 2, the first recommended period comes earlier than the second recommended period. That is, in the example illustrated in FIG. 2, the first recommended period is the earliest recommended period. Therefore, the management server 300 identifies the first recommended period as the reference period. In addition, the management server 300 identifies the maintenance item of the reference period as the reference item. In addition, the second recommended period comes in a predetermined period.

Here, in the present embodiment, the length of the predetermined period is decided for each maintenance item. Specifically, a predetermined period is decided in accordance with a maintenance item that is a candidate of an identified item among a plurality of maintenance items. In the example shown in FIG. 2, the length of the predetermined period corresponding to the maintenance item of the second recommended period is decided.

As described above, the second recommended period has arrived at the predetermined period. Therefore, the management server 300 identifies the maintenance item corresponding to the second recommended period as the identified item. Then, the management server 300 decides to maintain the maintenance item (identified item) recommended for maintenance in the second recommended period together with the reference item.

The management server 300 transmits the proposal information to the user terminal 200 via the network N1. Here, the proposal information is information for proposing a maintenance item recommended for performing maintenance to the user. The proposal information includes information for proposing maintenance of a reference item and maintenance of an identified item in a reference period.

In the present embodiment, the reference period and the recommended period for maintenance of the identified item do not overlap with each other. However, at least some of the recommended periods for the reference period and other maintenance items may overlap. In this case, the management server 300 may transmit, to the user terminal 200, proposal information for proposing maintenance of the reference item and the other maintenance item during a period in which the reference period and the recommended period for the other maintenance item overlap.

Further, in the present embodiment, the control unit 301 determines that the recommended period arrives in the predetermined period when part or all of the recommended period is included in the predetermined period. Specifically, the control unit 301 determines that the recommended period arrives in the predetermined period when the start period of the recommended period arrives within the predetermined period.

The management server 300 is configured to include a computer having a processor 310, a main storage unit 320, an auxiliary storage unit 330, and communication interfaces (I/F) 340. The processor 310 is, for example, Central Processing Unit (CPU) or Digital Signal Processor (DSP). The main storage unit 320 is, for example, a Random Access Memory (RAM). The auxiliary storage unit 330 is, for example, a Read Only Memory (ROM). The auxiliary storage unit 330 is, for example, a Hard Disk Drive (HDD), a CD-ROM, DVD disc, or a disc recording medium such as a Blu-ray disc. Further, the auxiliary storage unit 330 may be a removable medium (portable storage medium). Examples of the removable medium include a USB memory or an SD card. The communication I/F 340 is, for example, a Local Area Network (LAN) interface board or wireless communication circuitry for wireless communication.

In the management server 300, an operating system (OS), various programs, various information tables, and the like are stored in the auxiliary storage unit 330. In the management server 300, the processor 310 loads a program stored in the auxiliary storage unit 330 in the main storage unit 320 and executes the program, thereby being able to implement various functions described below. However, some or all of the functions of the management server 300 may be realized by hardware circuitry such as ASIC or FPGA. The management server 300 is not necessarily implemented by a single physical configuration, and may be constituted by a plurality of computers that cooperates with one another.

### User Terminal

The user terminal 200 is a terminal related to a user of the vehicle 10. Examples of the user terminal 200 include a computer or a portable information terminal used by a user of the vehicle 10. The user terminal 200 receives the proposal information from the management server 300 via the network N1. The user terminal 200 refers to the proposal information and displays, to the user, a maintenance item (a reference item and an identified item) for which maintenance is recommended in the reference period. As a result, the user can grasp the maintenance item recommended for maintenance in the reference period. The user terminal 200 includes a computer as well as the management server 300.

### Functional Configuration

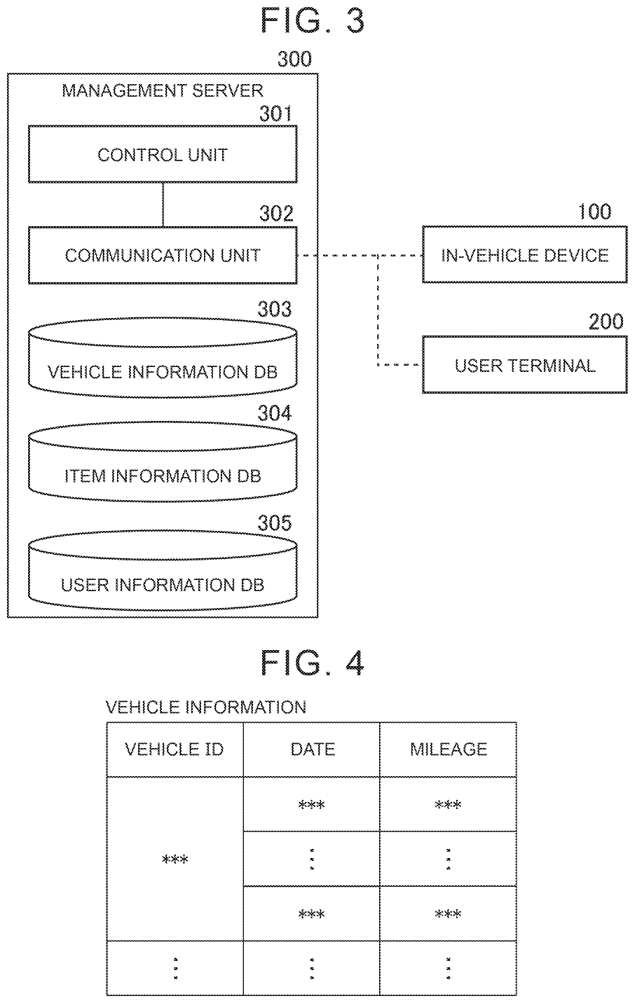

Next, the functional configuration of the management server 300 constituting the notification system 1 will be described with reference to FIG. 3 to FIG. 6. FIG. 3 is a block diagram schematically illustrating an example of a functional configuration of the management server 300. As illustrated in FIG. 3, the management server 300 includes a control unit 301, a communication unit 302, a vehicle information database 303 (vehicle information DB 303), an item information database 304 (item information DB 304), and a user information database 305 (user information DB 305).

The control unit 301 has a function of executing an arithmetic process required for controlling the management server 300. The control unit 301 can be realized by the processor 310 in the management server 300. The communication unit 302 has a function of connecting the management server 300 to the network N1. The communication unit 302 can be realized by a communication I/F 340 in the management server 300.

The control unit 301 receives the vehicle information of the vehicle 10 from the in-vehicle device 100 via the communication unit 302. The control unit 301 stores the received vehicle information in the vehicle information DB 303. The vehicle information DB 303 has a function of holding vehicle information. The vehicle information DB 303 can be realized by the auxiliary storage unit in the management server 300. Here, it is assumed that the longer the travel distance of the vehicle 10 is, the more deteriorated the components of the vehicle 10 are. Therefore, the vehicle information in the present embodiment corresponds to “information related to the deterioration state of the vehicle” according to the present disclosure. Further, the vehicle information does not necessarily have to be information including the travel distance of the vehicle 10. The vehicle information may be, for example, information including a detection value indicating a deterioration state of each component acquired by a sensor of the vehicle 10.

FIG. 4 is a diagram illustrating an exemplary table configuration of vehicle information held in the vehicle information DB 303. As illustrated in FIG. 4, the vehicle data includes a vehicle ID field, a date field, and a travel distance field. In the vehicle ID field, an identifier (vehicle ID) for identifying a vehicle is stored. The vehicle ID field stores the vehicle ID of the vehicle 10. In the date field, information (date) indicating the date on which the vehicle travels is stored. In the travel distance field, information indicating the distance (travel distance) traveled by the vehicle on the date in the date field is stored. Here, in the present embodiment, the vehicle information received by the control unit 301 from the in-vehicle device 100 includes information indicating a distance traveled by the vehicle 10 in a day. The control unit 301 stores information indicating the travel distance in the travel distance field on the basis of information indicating the distance traveled by the vehicle 10 in a day. Note that the control unit 301 may identify the travel distance based on the position information of the vehicle 10 received from the in-vehicle device 100 in real time.

The item information DB 304 has a function of holding item information. The item information is information including a travel distance that is recommended to perform maintenance corresponding to each maintenance item. Further, the item information is information including association between the maintenance item and the cost and importance of the maintenance item. The item information DB 304 can be realized by the auxiliary storage unit 330 in the management server 300.

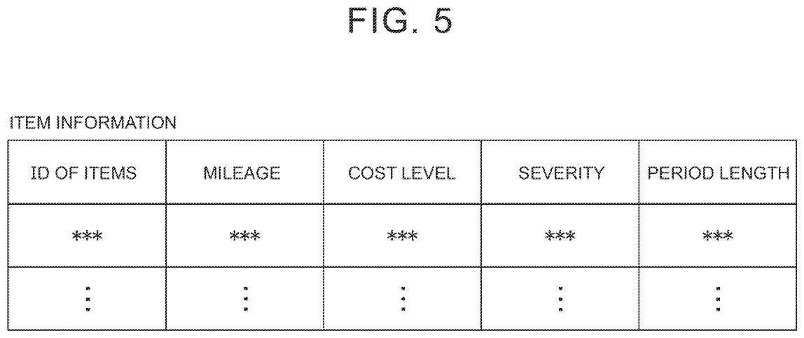

FIG. 5 is a diagram illustrating an exemplary table configuration of item information held in the item information DB 304. As illustrated in FIG. 5, the item information includes an item ID field, a travel distance field, a cost level field, an importance field, and a period length field. In the item ID field, an identifier (item ID) for identifying a maintenance item is stored. In the traveling distance field, information indicating a traveling distance of the vehicle, which is recommended to perform maintenance corresponding to the maintenance item corresponding to the item ID, is stored.

In the cost level field, information indicating a level of maintenance cost in the cost field is stored. The level of the maintenance cost is set such that the higher the maintenance cost, the higher the level. In the importance field, information indicating the importance of the maintenance item corresponding to the item ID stored in the item ID field is stored. Here, the importance is set to be higher as the maintenance item is more likely to adversely affect the traveling of the vehicle by not performing the maintenance.

In the period length field, information for specifying the length (period length) of a predetermined period corresponding to the maintenance item of the item ID corresponding to the item ID stored in the item ID field is stored. By referring to the period length indicated by the information stored in the period length field, the control unit 301 can grasp the length of the predetermined period corresponding to the maintenance-item of the item ID corresponding to the item ID stored in the item ID field.

The control unit 301 refers to the vehicle information held in the vehicle information DB 303 and the item information held in the item information DB 304, and decides a maintenance item for the vehicle 10 and a recommended period for the maintenance item. Specifically, the control unit 301 acquires the travel distance of the vehicle 10 at each date from the vehicle information. The control unit 301 calculates the transition of the travel distance of the vehicle 10 in the past from the travel distance of the vehicle 10 in each date. Further, the control unit 301 calculates a predicted value of the travel distance of the vehicle 10 in the future (hereinafter, may be simply referred to as a “predicted value of the travel distance”) based on the transition of the travel distance of the vehicle 10 in the past. As a predicted value of the traveling distance, a traveling distance in which the vehicle 10 is predicted to travel in one day is calculated. The predicted value of the travel distance is predicted, for example, by calculating an average value of the travel distances of the vehicles 10 in the past on the basis of the travel distances of the vehicles 10 in each date. As a method of calculating a predicted value of the travel distance of the vehicle 10 in the future, a known method can be adopted.

The control unit 301 identifies a date on which the predicted value of the travel distance is predicted to be equal to or more than the travel distance indicated by the information stored in the travel distance field in the item information held in the item information DB 304. Then, the control unit 301 decides a period of a predetermined length starting from the identified date as the recommended period. The control unit 301 stores information including a maintenance item and a recommended period for the maintenance item in the user information DB 305.

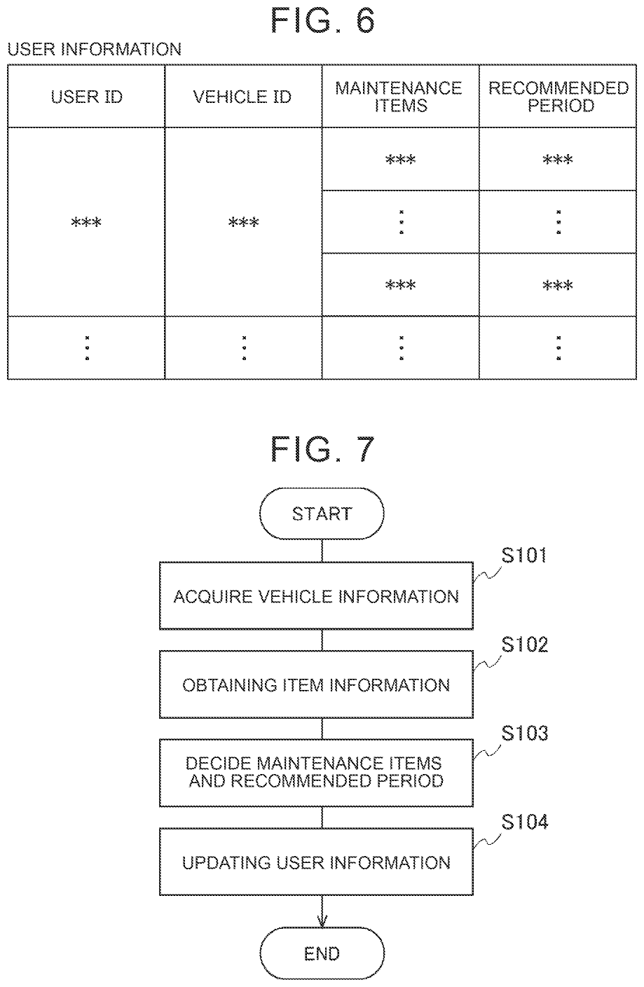

The user information DB 305 has a function of holding user information. The user information is information including a maintenance item for which maintenance is recommended and a correspondence relationship between recommended periods for the maintenance item. The user information DB 305 can be realized by the auxiliary storage unit 330 in the management server 300. FIG. 6 is a diagram illustrating an exemplary table configuration of user information held in the user information DB 305.

As illustrated in FIG. 6, the user information includes a user ID field, a vehicle ID field, a maintenance-item field, and a recommended period field. In the user ID field, user ID is stored. The vehicle ID is stored in the vehicle ID field. The maintenance item stores information indicating a maintenance item that is recommended for the user of the user ID stored in the user ID field to perform maintenance on the vehicle of the vehicle ID stored in the vehicle ID field. In the recommended period field, information indicating a recommended period for the maintenance item indicated by the information stored in the maintenance item field is stored.

The control unit 301 acquires the recommended period for the respective maintenance items from the user information held in the user information DB 305. The control unit 301 identifies, as a reference item, a maintenance item having the earliest recommended period among the recommended periods for the plurality of acquired maintenance items.

Further, the control unit 301 identifies another maintenance item different from the reference item as a candidate of the identified item. In addition, the control unit 301 refers to the item information held in the item information DB 304, and sets a predetermined period for the candidates of the identified item. Specifically, the control unit 301 acquires information specifying a length of a predetermined period (hereinafter, sometimes referred to as “period length”) stored in the period length field for a candidate of an identified item. Thus, the control unit 301 decides the period length corresponding to the identified item. Then, the control unit 301 sets the period of the period length for the identified item as a predetermined period from the start of the reference period. Here, when information indicating “one month” is stored in the period length field, a period of one month from the start of the reference period is set as a predetermined period. Here, the control unit 301 may set, as a predetermined period, a period of time length for a candidate whose recommended period is an identified item from the end of the reference period.

The control unit 301 determines whether or not the recommended period of the maintenance item arrives in a predetermined period for the maintenance item of the candidate of the identified item. That is, the control unit 301 determines whether or not the candidate of the identified item is the identified item. Then, when determining that the maintenance item of the candidate of the identified item is the identified item, the control unit 301 decides to perform the maintenance of the identified item together with the reference item. Then, proposal information proposing maintenance of an identified item together with the reference item in the reference period is transmitted to the user terminal 200.

### First Process

Next, a first process executed by the control unit 301 of the management server 300 in the notification system 1 will be described with reference to FIG. 7. FIG. 7 is a flowchart of a first process executed by the control unit 301. The first process is a process for deciding a maintenance item and a recommended period corresponding to the maintenance item with reference to the vehicle information. The first process is repeatedly executed at predetermined intervals.

In the first process, first, in S101, vehicle information is acquired from the vehicle information DB 303. Further, in S102, item information is acquired from the item information DB 304. Next, in S103, a maintenance item and a recommended period for the maintenance item are decided based on the predicted value of the travel distance calculated by referring to the vehicle information and the information stored in the travel distance field in the item information. Next, in S104, the user information is updated by storing the maintenance item and information indicating the recommended period of the maintenance item in the user information. Then, the first process is terminated once.

### Second Process

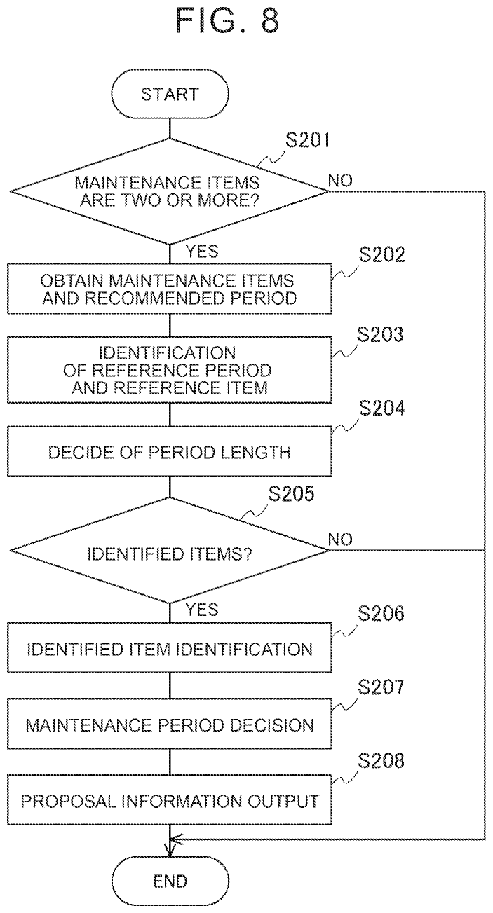

A second process executed by the control unit 301 of the management server 300 in the notification system 1 will be described with reference to FIG. 8. FIG. 8 is a flowchart of a second process executed by the control unit 301. The second process is a process for deciding to perform maintenance of an identified item in a reference period. The second process is repeatedly executed at predetermined intervals.

In the second process, first, in S201, the user information held in the user information DB 305 is referred to, and it is determined whether or not two or more maintenance items are included in the user information. If a negative determination is made in S201, maintenance of the vehicle 10 is not recommended, or maintenance of one maintenance item is recommended for the vehicle 10. When maintenance of the vehicle 10 is not recommended, the user does not need to perform maintenance of the vehicle 10. In addition, in a case where maintenance of one maintenance item is recommended for the vehicle 10, the user does not need to perform other maintenance in the reference period. Therefore, if a negative determination is made in S201, the second process is once terminated.

When an affirmative determination is made in S201, two or more maintenance items and a recommended period for the respective maintenance items are acquired. Next, in S203, the user information is referred to, and the reference period and the reference items are identified. In addition, in S204, a period length for each maintenance-item for which a predetermined period has been acquired is decided. As a result, a predetermined period corresponding to the maintenance item in which the predetermined period is acquired is set. Next, in S205, it is determined whether or not an identified item exists in the maintenance item acquired in S202. That is, in S205, it is determined whether or not an identified item exists in the candidates of the identified item.

Here, when three or more maintenance items are acquired in S202, whether or not the maintenance item is a identified item is determined for each maintenance item other than the reference item. Then, it is determined whether or not an identified item exists in three or more maintenance items.

If a negative determination is made in S205, the second process is terminated once because there are no identified items. In addition, when an affirmative determination is made in S205, the identified items are identified.

Next, in S207, a period (maintenance period) during which maintenance of an identified item is performed is decided to be performed in the reference period. That is, in S207, it is decided to maintenance the identified item together with the reference item. Here, when a plurality of identified items is identified in S206, it is decided that maintenance of all the identified items is performed in the reference period. Next, in S208, the suggestion is outputted to the user terminal 200. Then, the process illustrated in FIG. 2 is ended.

As described above, in the notification system 1, the maintenance of the identified item is decided to be performed together with the reference item in the reference period. As a result, maintenance of the vehicle 10 is suppressed in a plurality of recommended periods in which the users do not overlap each other. As a result, it is possible to improve convenience when the user performs maintenance of the vehicle 10.

### First Modification

In the present embodiment, the length of the predetermined period is decided according to the maintenance item. However, the length of the predetermined period may be decided uniformly regardless of the maintenance item.

### Second Modification

In the present modification, the maintenance item having a high maintenance cost for the vehicle 10 is decided so that the length of the predetermined period becomes shorter. That is, in the item information held in the item information DB 304, the period length indicated by the information stored in the period length field is set to be shorter as the cost level indicated by the information stored in the cost level field is higher.

As a result, a predetermined period for a maintenance item with a high maintenance cost is set to a shorter period than a maintenance item with a low maintenance cost. Therefore, it is suppressed that a maintenance item with a high maintenance cost is identified as an identified item rather than a maintenance item with a low maintenance cost. In this case, the maintenance of the maintenance item whose maintenance cost is high is more likely to be performed in the recommended period that comes after the reference period than in the maintenance item whose maintenance cost is low. Accordingly, it is possible to suppress the number of times of performing the maintenance of the maintenance item in which the maintenance cost is high during the entire period in which the vehicle 10 is used. As a result, it is possible to improve convenience when the user performs the maintenance of the vehicle 10 while suppressing the maintenance cost.

### Modification 3

In the present modification, the maintenance item having a high degree of importance of maintenance for the vehicle 10 is decided so that the length of the predetermined period becomes longer. That is, in the item information held in the item information DB 304, the period length indicated by the information stored in the period length field is set to be longer as the importance indicated by the information stored in the importance level field is higher. Therefore, a maintenance item having a high importance is more easily identified as an identified item than a maintenance item having a low importance. In this case, the maintenance of the maintenance item with high importance is more likely to be performed in the reference period that arrives earlier than the recommended period than in the maintenance item with low importance. As a result, it is possible to improve convenience when the user performs maintenance of the vehicle 10 while improving the safety of the vehicle 10.

### Other Embodiments

The above-described embodiments are mere examples, and the present disclosure can be implemented with appropriate modifications within a range not departing from the scope thereof. Moreover, the processes and units described in the present disclosure can be freely combined and implemented unless technical contradiction occurs.

Further, the processes described as being executed by one device may be shared and executed by a plurality of devices. Alternatively, the processes described as being executed by different devices may be executed by one device. In the computer system, it is possible to flexibly change the hardware configuration (server configuration) for realizing each function.

The present disclosure can also be implemented by supplying a computer with a computer program that implements the functions described in the above embodiment, and causing one or more processors of the computer to read and execute the program. Such a computer program may be provided to the computer by a non-transitory computer-readable storage medium connectable to the system bus of the computer, or may be provided to the computer via a network. Examples of the non-transitory computer-readable storage medium include a random disk (such as a magnetic disk (a floppy (registered trademark) disk, an HDD, and the like) or an optical disc (such as a CD-ROM, a DVD disc, and a Blu-ray disc)), a ROM, a RAM, an EPROM, an EEPROM, a magnetic card, a flash memory, an optical card, and a random type of medium suitable for storing electronic instructions.

What is claimed is:

1. An information processing device comprising: a control unit configured to execute
acquisition of a recommended period for recommendation to perform maintenance of a vehicle for each of a plurality of maintenance items,
identification of, with an earliest recommended period of the recommended period that is acquired as a reference period, a maintenance item of the earliest recommended period out of the maintenance items, as a reference maintenance item,
identification of another maintenance item out of the maintenance items that is different from the reference maintenance item that is identified, and of which the recommended period will arrive in a predetermined period that includes the reference period that is identified, and
decision to perform maintenance of the other maintenance item that is identified, along with the reference maintenance item.

2. The information processing device according to claim 1, wherein:
the control unit is configured to further execute decision of a length of the predetermined period, in accordance with a maintenance item that is a candidate of the other maintenance item, out of the maintenance items; and
identifying the other maintenance item includes identifying another maintenance item out of the maintenance items, in which the recommended period will arrive in the predetermined period of the length including the reference period that is identified.

3. The information processing device according to claim 2, wherein the higher a maintenance expense regarding the vehicle is for a maintenance item, the shorter the predetermined period is decided to be for that maintenance item.

4. The information processing device according to claim 2, wherein the higher a degree of importance of maintenance regarding the vehicle is for a maintenance item, the longer the predetermined period is decided to be for that maintenance item.

5. The information processing device according to claim 1, wherein the control unit is further configured to execute
acquisition of information related to a state of deterioration of the vehicle, and
decision of the recommended period for each of the maintenance items in accordance with the state of deterioration.
